(19) United States
(12) Patent Application Publication
(10) Pub. No.: US 2013/0045902 A1
(43) Pub. Date: Feb. 21, 2013

(54) COMPOSITION AND METHOD FOR RECOVERING HEAVY OIL

(71) Applicants: Todd Matthew Thompson, Lake Forest, CA (US); Kevin David Grace, Lake Forest, CA (US)

(72) Inventors: Todd Matthew Thompson, Lake Forest, CA (US); Kevin David Grace, Lake Forest, CA (US)

(21) Appl. No.: 13/585,209

(22) Filed: Aug. 14, 2012

Related U.S. Application Data
(60) Provisional application No. 61/524,298, filed on Aug. 16, 2011.

(51) Int. Cl. C10G 1/04; F17D 1/16; E21B 43/24; C09K 8/58; E21B 43/22

(52) U.S. Cl. 507/261; 208/390; 166/263; 166/268; 166/400; 137/13

(57) ABSTRACT

A chemical composition and methods for use in the recovery of viscous oil and other desired hydrocarbons from subterranean reservoirs and from excavated material comprising oil sands or oil shale, and to remediate contaminated soil and subterranean reservoirs. Adding the composition to viscous oil renders it pipelineable by significantly reducing its viscosity. The chemical composition comprises an alkane, an ether, and an aromatic hydrocarbon. The composition is an organic solvent mixture that interacts highly favorably with non-polar hydrocarbons but is mostly immiscible with water and acts as a diluent, lowering the viscosity and raising the specific gravity of viscous oil. Additional water and heat are not required. Methods of using the composition in subterranean reservoirs and with excavated material including oil sands or oil shale and contaminated soil and subterranean reservoirs needing remediation, are highly efficient, economical, and reduce or eliminate adverse environmental consequences.

### CLAIM OF BENEFIT TO RELATED APPLICATIONS

This application claims the benefit of U.S. Provisional Application No. 61/524,298, filed Aug. 16, 2011. The contents of application 61/524,298 are incorporated herein by reference.

### BACKGROUND OF THE INVENTION

1. Field of Invention

The present invention relates to a composition for use in the recovery of viscous oil and other targeted hydrocarbons, to a new method of viscous oil recovery from subterranean formations, to a new method of recovering viscous oil and other hydrocarbons from surface-mined oil sands and oil shale, and to a new method of improving the pipeline transport of viscous oil.

2. Description of Prior Art

Increased global demand for oil, together with concerns regarding the depletion of energy reserves currently recoverable via conventional means, has created the need for more efficient recovery techniques. Recovery of crude oil from oil sands via both in situ and surface-mined approaches is an area in which improved methodologies should prove highly beneficial.

High viscosity oil deposits constitute a large fraction of global reserves, totaling in the trillions of barrels. The heavy oil and bitumen-rich sands of the Athabasca Tar Sands in Alberta, Canada, the Orinoco Belt in Venezuela, and formations in China, Russia, Indonesia and Utah in the United States, represent significant reserves.

Oil sands are composed of a mixture of bitumen, water, and mineral-containing soils such as sand, silt and clay. Bitumen is a highly viscous mixture of oils, resins and asphaltenes. Asphaltenes are operationally defined as the n-heptane insoluble, toluene soluble, fraction of bitumen or crude oil. They possess high molecular weights, averaging approximately 750 Da, and contain carbon, hydrogen, nitrogen, oxygen and sulfur atoms, as well as trace metals. The nitrogen and oxygen atoms make asphaltenes somewhat less non-polar than other constituents of “heavy oil” or bitumen. Heavy oil has an American Petroleum Institute (API) gravity under 20, while “super heavy oil” has an API under 10.

Recovery of heavy oil is inherently difficult. It cannot typically be recovered from oil sands through basic gravity well operation alone, as the low API gravity and high viscosity of the formations impede fluidity.

Basic water flooding is relatively ineffective with oil sands due to the unfavorable mobility ratio, thus oil sands must either be subjected to more complex, in situ recovery methods, or surface-mined. Deeper reserves may be recovered in situ via thermal and solvent-based techniques that reduce the viscosity of oil by many orders of magnitude and increase drive pressure.

A well can undergo cycles of steam injection and long soak periods prior to oil production via a process known as Cyclic Steam Stimulation (“CSS”), or “huff and puff.” This improves oil mobility and allows for recovery efficiency of 20 to 25%. Nevertheless, CSS is expensive and requires large quantities of heated water. Heating the water involves burning natural gas or using other energy sources, and the process emits a significant quantity of carbon dioxide. Additionally, water that is recovered along with oil needs to be treated, as it commonly contains heavy metals including lead, vanadium, mercury and cadmium.

Steam Assisted Gravity Drainage (“SAGD”) is a method involving the use of two horizontal wells, vertically separated by roughly 5 m at the bottom of the well. Steam is injected into the reservoir from the upper well, melting bitumen which then flows to the lower well and is pumped from the production well. Recovery efficiency with SAGD is similar to that of CSS. Likewise, it bears the same adverse consequences as CSS, namely the use of vast quantities of heated water and the resultant impact on the environment.

Vapor extraction (“VAPEX”) uses liquefied solvents such as ethane, propane or butane to lower the viscosity of oil and drive its displacement towards a second, deeper horizontal well, in a somewhat similar manner as SAGD. Though not strictly necessary, VAPEX is usually carried out in the presence of steam. While more economical than SAGD, it remains expensive and can generate significant greenhouse gases when steam is used.

The described in situ methods of extracting heavy oil are popular, but notable downsides to their use exist. The methods tend to be costly and often require a significant amount of natural gas in order to provide a sufficient quantity of heated water. The production of heated water generates large quantities of greenhouse gas emissions.

Surface-mined, or ex situ, extraction from oil sands is the most effective approach when reserves are close to the surface and not burdened by heavy overgrowth of vegetation. Recovery begins with the excavation of raw material, often using power shovels or draglines.

Subsequently, variations of the “hot water” method are often used to process mined bitumen from the Athabasca Tar Sands. The hot water method essentially relies on water to separate bitumen from sand.

In the hot water method, hot water streams condition oil sands in large drums. Sodium hydroxide is added to maintain an alkaline pH. Large clumps disintegrate and the oil sands release bitumen and sand particles. The bitumen is aerated and a slurry is formed from bitumen and other solids. The slurry is removed and diluted with hot water to aid in the separation of sand and bitumen. The slurry is added to a moderately heated separation vessel and a bitumen froth rises to the top, while the sand fraction drops to the bottom of the vessel and is subsequently removed. Naptha may be added to the bitumen froth to reduce its viscosity, and the froth is then centrifuged to further purify the bitumen fraction. The “middlings,” a combination of sand, bitumen and water found in the fraction in the middle of the vessel, also undergo further separation in order to improve bitumen recovery. Not surprisingly, the hot water method requires large quantities of water. Natural gas is typically used to heat that water, generating carbon dioxide emissions. Additionally, the resulting tail ponds are huge and the water contained therein may be unusable for many years and can potentially contaminate groundwater if not effectively contained.

The bitumen fraction must still be upgraded through various techniques, including thermal conversion, catalytic conversion, distillation and hydrotreating. These serve to remove excess carbon, water, nitrogen, sulfur and trace metals. Approximately two tons of oil sand is required to produce a barrel of synthetic crude oil.

The use of solvent methods in the extraction of oil and other desired hydrocarbons from oil sand and oil shale is known in the art. U.S. Pat. No. 3,475,318 describes the extraction of tar from oil sand using hydrocarbons with 5 to 9 carbon atoms. Multi-stage solvent recoveries are also known, as described in U.S. Pat. No. 4,046,668, where raw material is treated with naptha and then methanol. Most of these solvent methods require the addition of extremely hot water or steam, as described in US. Pat. Nos. 3,475,318 and 4,189,376. The high cost of these processes, the use of multiple filtration steps, the excessive solubility of fines, along with growing public concerns regarding the excessive use of heated water, illustrate the need for alternative approaches.

Oil shale reserves total several trillions of barrels worldwide, but it is cost prohibitive to recover most of these reserves. There are variations in ex situ methodologies, but commonly, shale is heated to temperatures in excess of 425° to 480° C. This process, known as retorting, degrades the kerogen with which oil shale is associated. Often a number of other components remain, including nitrogen, oxygen, and a significant amount of alkenes. In addition to the cost of recovery processes, the high temperature yields large amounts of waste and generates significant quantities of carbon dioxide.

Remediation of undesirable organic wastes is generally accomplished through high temperature processes. Techniques exist involving fluid based incineration in which contaminated soil is heated to 260° C. or more and rotated in a large drum. To avoid releasing contaminated vapor, material is sent to an afterburner which superheats it to further break down remaining organics. Similarly, the Alberta Taciuk Process is a retort process involving a rotary kiln. The process has been used successfully in several large remediation projects. These methods illustrate that organic waste can be successfully eliminated, but it is a costly endeavor, particularly in terms of initial capital expenses.

Beyond its production and processing, heavy oil creates challenges in terms of transport. Pipelines represent the only large scale means of transporting heavy oil from land-based reserves that are often in remote locations, yet due to its high viscosity, heavy oil does not flow well.

A variety of approaches exist to deal with the transportation problem. Heated pipelines can facilitate heavy oil flow. In addition to corrosion concerns, engineering a heated pipeline requires factoring in variables such as the expansion of the pipes due to heat, the location of pumping and heating stations, and potential power and equipment failures and the concomitant clogging of the pipeline due to heavy oil that has cooled down. Effectively re-starting a cooled pipeline involves relatively complex fluid dynamic calculations. Simpler, more economical means of improved pipeline transport are necessary for the optimal exploitation of heavy oil reserves.

Full or partial upgrading of the recovered heavy oil via thermal conversion represents a subset of approaches. This reduces the viscosity while raising the API gravity of the heavy oil, improving its fluidity. Asphaltene precipitation can occur in oil upgraded in this manner. Refineries prefer not to process upgraded oil due to its resinous nature.

The addition of low viscosity diluents such as natural gas condensates and naptha to heavy oil represents a useful method of rendering it pipelineable. The approach is far simpler than conversion techniques or heated pipelines. Diluent practice bears several potential problems, however. The availability of natural gas condensate is a limiting factor in some locations. The volume of certain diluents required in order to lower the heavy oil's viscosity to an acceptable level for flow purposes can simultaneously raise the API gravity of that oil beyond a desirable value. Asphaltene precipitation can occur with the use of certain combinations of heavy oils and various diluents.

Accordingly, there is a need for improved methods of in situ recovery of oil from oil sand, and for improved surface-mined extraction of desirable hydrocarbons from oil sand and oil shale. More efficient recovery via effective, inexpensive solvent-based processes that minimize the use of water, and in particular heated water, should greatly benefit the industry and the environment. A solvent extraction mixture that prevents emulsion formation in downhole recovery is desirable. Eliminating the hazardous tail ponds created by the use of the hot water method of recovery is another aspect that will bring significant benefits to the environment. Improved remediation techniques would complement the new, improved means of recovering oil. Finally, there is a need for a simple, economical approach to rendering viscous oil for pipeline transport.

### SUMMARY OF THE DISCLOSURE

In some embodiments, an economical chemical composition for enhanced recovery of heavy oil and other targeted hydrocarbons, comprising a solvent mixture of an alkane having from five to nine carbon atoms, an ether, and aromatic hydrocarbon, is included. The composition represents a low energy separation technology for oil recovery. It can be used to extract oil without the extensive water and heat requirements of current methodologies.

In some embodiments, a method for the enhanced recovery of oil from subterranean reservoirs by the introduction of the chemical composition is included. The composition can be injected into the subterranean reservoir to improve recovery at any time in the life of the well. The chemical composition serves as a solvent and diluent, penetrating the formation and then lowering the viscosity and raising the specific gravity of oil that it contacts, facilitating its extraction. At standard well depths, modest heat from the earth's geothermal gradient supplements the ability of the composition to recover oil. Oil is then recovered at a production well, though a single, two-way well could be used for the process if depth, geology and pressure are favorable. This method can also be used to improve the recovery of oil of standard viscosity, in addition to the aforementioned heavy oil from bituminous formations. As well, the same approach can be used for in situ remediation of undesirable hydrocarbons.

In some embodiments, the recovery of oil from surface-mined oil sands is included. The method includes using a “sizing process” to render excavated oil sands much smaller and more uniform in size. The crushed particulate matter is then mixed with the chemical composition, extracting the oil fraction from bitumen. After sufficient time, the mixture is filtered and the liquid filtrate is moderately heated to remove the chemical composition, before being further treated to yield purified oil.

In some embodiments, the recovery of oil from surface-mined oil shale is included. The method includes using a sizing process to render excavated oil shale smaller in size. It should be noted that the particulate size and porosity is particularly critical to the recovery of oil from shale, and the shale containing substrate must be either highly pulverized or highly porous material. The crushed particulate matter is then mixed with the chemical composition, extracting the oil fraction. The mixture is filtered and the liquid filtrate is heated to remove the chemical composition, before undergoing further treatment to yield purified oil.

In some embodiments, the use of the chemical composition to remediate soil sources contaminated with unwanted hydrocarbon products is included. Similar to its ability to assist in the recovery of heavy oil, the solvent mixture readily dissolves oil and other relatively non-polar, hydrocarbons, and it allows complex, somewhat more polar hydrocarbon molecules, such as asphaltenes, to stay in a stable, dispersed form without precipitating.

In some embodiments, the use of the chemical composition to render heavy oil suitable for pipeline transportation is included. The method includes adding a sufficient amount of the chemical composition to recovered heavy oil, thus lowering the viscosity and raising the specific gravity of the heavy oil, without causing asphaltene precipitation.

### BRIEF DESCRIPTION OF THE DRAWINGS

FIG. 1 is a schematic cross-sectional diagram representing a method for obtaining oil from a subterranean reservoir while using at least one injection well and at least one production well in accordance with an embodiment of the invention.

FIG. 2 is a schematic cross-sectional diagram representing a method for remediating undesirable hydrocarbons or for recovering oil from a formation, while using a single two-way well in accordance with an embodiment of the invention.

FIG. 3 is a schematic diagram representing a method for obtaining oil or other hydrocarbons from surface-mined oil sand, shale, or other hydrocarbon-containing material in accordance with an embodiment of the invention.

FIG. 4 is a simple block flow diagram representing a method of preparing and transporting heavy oil from the production site to a refinery.

FIG. 5 is a graphical representation of the results of viscosity testing performed at various temperatures on a series of dilutions of the solvent mixture and super heavy oil, as in Table 1.

FIG. 6 is a chromatogram displaying the elution profile of the upper liquid fraction extracted from a shale sample treated with the chemical composition.

### DETAILED DESCRIPTION

Definitions

Unless defined otherwise, technical and scientific terms used herein have the same meaning as that understood by persons of ordinary skill in the art. In the event of ambiguity concerning the precise meaning of a term, the definitions and explanations contained within the present specification will control.

As used herein, the terms “alkane” or “paraffin” refer to a molecule consisting of hydrogen and carbon atoms with the general formula CₙH₂ₙ₊₂, where n represents the number of carbon atoms. It is also referred to as a “saturated” hydrocarbon. Alkanes are generally very stable and relatively unreactive under standard conditions.

As used herein, the term “bitumen” refers to oil having a viscosity of roughly 10,000 centipoises (cP) or greater.

As used herein, the term “ether” refers to any member of the class of organic compounds formed of carbon, hydrogen, and oxygen atoms and possessing an ether group. An ether group is an oxygen atom linked to two hydrocarbon groups.

As used herein, the term “fines” refers to very small clay particles that are often present during the recovery of oil from oil sands. They can remain suspended in water for many years following the hot water method of oil recovery.

As used herein, the term “hydrocarbon-containing matter” refers to any substance comprising a hydrocarbon. Hydrocarbon-containing matter may entail hydrocarbon molecules in gaseous, liquid, or solid states.

As used herein, the terms “includes,” “including,” “comprises,” and “comprising” are intended to be inclusive or open-ended, and do not exclude additional, un-recited elements or method steps.

As used herein, the term “kerogen” refers to a mixture of naturally occurring, high molecular weight, largely insoluble, non-volatile organic material found in sedimentary rock, including oil shale. Kerogen is typically derived from algal sources.

As used herein, the term “remediation” refers to the process of removing hazardous environmental contaminants from a medium such as soil or water.

As used herein, the term “sizing process” refers to the process by which solid matter is mechanically crushed, pulverized or otherwise broken, yielding relatively uniform particles.

As used herein, the term “solvent mixture” refers to the chemical composition described in this document.

As used herein, the term “tail pond” refers to a water-filled area containing leftover residue, or “tailings,” of water, clay, sand and residual hydrocarbons generated during the recovery of crude oil from oil sand or oil shale. It can represent a significant environmental hazard.

As used herein, the term “wash phase” refers to the process by which material that has been excavated and mechanically crushed is treated with the chemical composition of this disclosure.

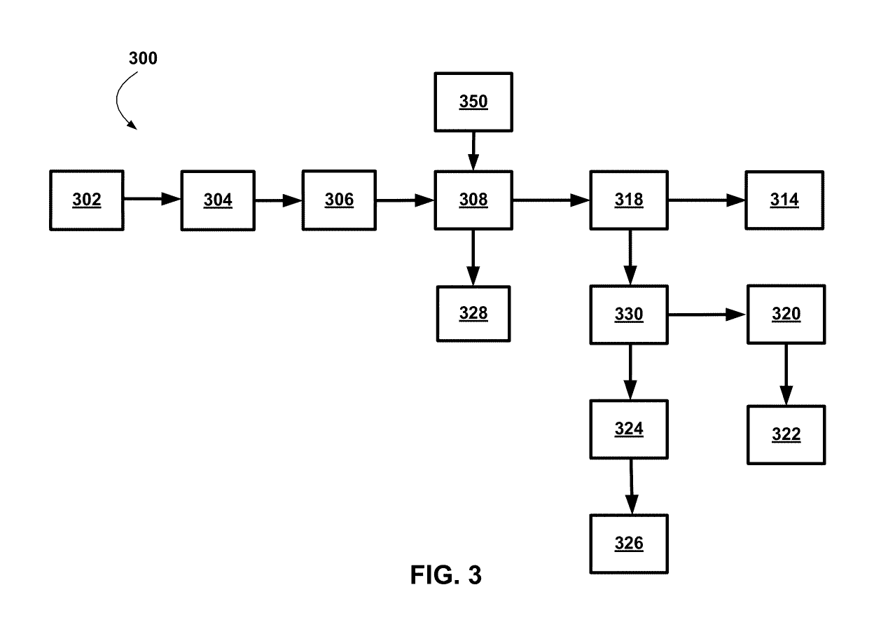

Disclosed is a chemical composition comprised of solvents from three chemical classes. Various methods of using the composition are also disclosed. The composition is extremely effective at recovering oil and other hydrocarbons across a broad array of applications and methodologies. The composition is relatively non-polar, which provides the appropriate chemical environment for interactions with non-polar hydrocarbons, including oil. Its ability to penetrate and release oil can be applied towards recovery efforts in subterranean reservoirs and treatment of excavated and pulverized material from oil sand or oil shale deposits Likewise, the qualities of the chemical composition make it suitable for solvent-assisted remediation efforts directed at removing undesirable hydrocarbons. The basic properties of the solvent mixture readily allow for solvent recycling in above ground methods using surface-mined substrate (see FIG. 3). Recycling is beneficial from both economic and environmental perspectives.

Traditional steam-based techniques used for in situ recovery of viscous oil require vast quantities of water, as well as the energy to heat that water. It is highly advantageous to have a more effective process that requires little, if any, water, while simultaneously generating higher recovery yields. The solvent mixture described herein meets these criteria. Solvents can be selected appropriately to ensure vaporization under typical conditions, and immiscibility in water.

In embodiments for use with both in situ recovery and surface-mined applications, the solvent mixture must be capable of penetrating hydrocarbon-containing material and dissolving the target hydrocarbons. The solvent mixture can vaporize under typical operating temperatures, generating a driving force to assist in gravity-based recovery. This reduces the need for large quantities of water, and it reduces the risk of groundwater contamination compared to solvents capable of liquefying under similar conditions. Ground and formation temperatures influence boiling point determinations, and thus may play a role in determining the choice of chemical components. While vaporization presents some advantages, the chemical composition functions highly effectively at lower temperatures as well.

Immiscibility of the solvents comprising the chemical composition in water is preferred. Immiscibility reduces the number of required steps and lowers costs, while enhancing recovery efficiency. It also translates into a greatly reduced risk of groundwater contamination.

The solvent mixture is capable of extracting bitumen from all three of its constituent fractions: oil, resins and asphaltenes. Two important consequences of bitumen's solubility in the solvent mixture composition are the drastically reduced viscosity and the increased specific gravity of the recovered solute. The ability of the solvent mixture to permeate hydrocarbon-containing matter can be enhanced by reducing particulate size. Sizing is an integral aspect of many existing oil sand and oil shale recovery processes. Mechanical grinding is a standard protocol, and it usually yields gravel-sized material. New sizing processes are emerging though, including cyclonic approaches. Cyclonic methods involve extremely high powered air currents moving particles at high velocity within a chamber. Collisions between particles in the chambers causes them to fragment. Novel approaches such as this may ultimately prove to be more cost effective and to generate finer material than conventional grinding techniques.

In an embodiment, the chemical composition comprises a saturated hydrocarbon, an ether, and an aromatic hydrocarbon. The saturated hydrocarbon comprises a five to nine carbon alkane. The ether comprises diethyl ether, methyl n-propyl ether and methyl tert-butyl ether. The aromatic hydrocarbon comprises toluene, benzene, ethylbenzene, xylene isomers, cumene or durene. Physical and chemical characteristics of the individual solvents in this composition are known in the art, yet the described chemical composition's synergistic ability to recover oil was unanticipated. Without knowing the precise mechanism for the unexpected abilities of the solvent mixture, it should be noted that while the components of the chemical composition are all relatively non-polar, the small ether molecule has a larger dielectric constant than the alkane and aromatic hydrocarbon molecules.

The saturated hydrocarbon comprises alkanes, commonly referred to as paraffins in the oil industry. Alkane molecules having from five to nine carbon atoms may be chosen for the alkane component of the composition. This corresponds to pentane, hexane, heptane, octane and nonane, and their isomers. The alkane component of the solvent mixture described by the chemical composition herein may be present in an amount based on the total solvent mixture from about 60 to about 80 wt %. The alkane component to the solvent mixture is particularly useful in solubilizing alkanes and any other extremely non-polar constituents of oil.

Boiling point is another consideration when choosing which alkane to use in the chemical composition. Smaller alkane molecules have correspondingly lower boiling points, and for any given number of carbons, a branched-chain alkane will have a lower boiling point than its straight-chain isomer. Transportation and handling become more significant issues as the boiling point decreases. The boiling point of pentane and its branched chain isomers fall within the workable range for the chemical composition, for example. Straight chain pentane has a boiling point of 36° C., while its two branched isomers, 2-methylbutane and 2,2-dimethylpropane, have boiling points of 28° C. and 10° C., respectively. Some degree of vaporization by pentane would allow the chemical composition to better penetrate heavy oil, particularly downhole, leading to potentially improved recovery.

Though relatively inert, alkanes interact with compounds containing similar molecules, including oil, natural gas, and other non-polar hydrocarbons, through weak molecular interactions such as London dispersion forces. Heavy oil generally lacks lighter weight molecules such as smaller alkanes due to biodegradation, and this is one of the reasons for its higher density. Reintroducing a significant quantity of lighter alkanes to heavy oil effectively lowers the oil's average molecular weight and density.

It is understood that commercial blends that contain alkanes and perhaps additional compounds could be used as a source of alkanes. Empirical evidence suggests that this approach is not as efficient as those focusing on a narrower range of alkanes, as described in this disclosure. As a by-product of oil and gas refining processes, alkanes are available in large quantities.

In an embodiment, the chemical composition includes a relatively small ether molecule with two alkyl subgroups. The ether used in the solvent mixture described by the chemical composition herein may be present in an amount based on the total solvent mixture from about 24 to about 32 wt %. Diethyl ether is an example of an ether that is known to work well. Methyl n-propyl ether and methyl tert-butyl ether (“MTBE”) are other ethers of note.

The ether component to the chemical composition greatly enhances the overall performance of the solvent mixture, far beyond expectations. The precise nature of ether's role in the chemical composition is not fully understood yet, but its presence appears to assist in preventing asphaltene precipitation. The relatively small ethers recommended are more polar than the other chemicals in the chemical composition. The ethers exhibit dipole-dipole forces due to unbound electron pairs at the oxygen, in addition to possessing weaker London dispersion forces. As ether molecules are unable to engage in hydrogen bonding amongst themselves, they have comparatively low boiling points, thus promoting the preferred transition to a vapor state.

In accordance with the desired properties of the solvent mixture, the ether should be immiscible, or at least have limited miscibility with water under operating conditions. Diethyl ether and MTBE both display somewhat limited solubility in water. MTBE has come under considerable regulation in the United States and some other countries as a result of this groundwater contamination. This occurred following the widespread adoption of MTBE as an octane booster for gasoline.

Ethers contemplated by this disclosure are commercially available. The synthesis of these compounds is well known to versed in organic chemistry, and large yields can be produced by chemical compounders where necessary. It is known to people having ordinary skill in the art that many ethers, with exceptions such as MTBE, can form peroxide molecules in the presence of oxygen, and thus must be handled appropriately. In particular, care should be taken with ether compounds by avoiding long-term storage, keeping them in tightly closed containers protected from light, and by adding a desiccant. Fortunately, industrially-available ethers can be obtained with stabilizers, such as butylated hydroxytoluene (BHT) at very low concentrations, or even ethanol, both of which greatly lower the risk of explosion. Efficiency of the solvent mixture is unaffected by the presence of BHT.

Suitable aromatic hydrocarbons include toluene, benzene, ethylbenzene, xylene isomers, cumene and durene, or mixtures thereof. The aromatic hydrocarbon component may be present in the solvent mixture in an amount based on the total solvent mixture from about 2.5 to about 3.5 wt %. As with the other components to the solvent mixture, immiscibility with water is preferable and fortunately the aromatic hydrocarbons have very limited solubility in water. A relatively low boiling point is a consideration as well. Toluene boils at about 111° C., somewhat higher than water, while benzene boils at roughly 80° C. While its boiling point is elevated compared to benzene's, toluene is environmentally favored. Economic factors are, of course, also critical to the adoption of various methodologies in the energy sector. The costs associated with toluene are reasonable for large scale, industrial operations.

Heavy oil tends to contain a higher percentage of aromatic hydrocarbons than do the lighter crudes. One major function of the aromatic hydrocarbon component of the chemical composition is to enhance the solubility of the heavy oil, which it accomplishes through its shared aromatic chemistry.

All chemicals can be purchased in industrial grade form from numerous suppliers. There is no special or preferred method of mixing together the chemicals to form the composition. In some instances, the inventors started with the alkane component and then added the aromatic hydrocarbon to the alkane. The ether was subsequently added to the alkane-aromatic hydrocarbon mixture. This is not an exclusive method of mixing the chemicals, however.

The solvent mixture can be used for recovery of heavy oil from a variety of different formations. Oil sands and other viscous oil deposits lend themselves to the solvent mixture and associated methods, though conventional reservoirs lacking the sufficient drive pressure represent another application. Heavy oil from different reserves can differ in terms of composition and viscosity. Embodiments of the chemical composition described herein allow for flexibility to modify parameters through experimentation in order to best meet the particular requirements of a heavy oil reserve. Similarly, embodiments of the chemical composition described herein can be optimized for recovery of other compounds, such as oil shale.

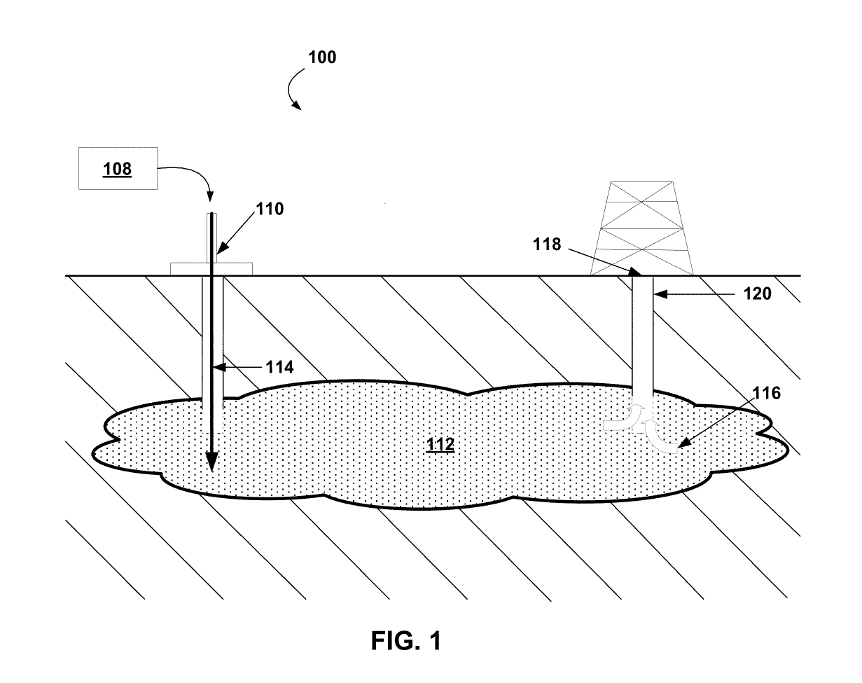

FIG. 1 shows a method 100 of recovering heavy oil 116 or other hydrocarbons, including undesirable hydrocarbons that are being remediated, from a subterranean reservoir 112 in accordance with an embodiment of the invention. To facilitate the flow of oil 116 once pressure from connate gas dissipates, or to increase the flow of more viscous oil 116 even prior to the loss of naturally existing gas drive, the solvent mixture 108 is introduced into the reservoir 112 via a delivery tube 114 in one or more injection wells 110 that extend through the earth into the subterranean reservoir 112 containing the target oil 116. In this figure, one injection well 110 is displayed.

The solvent mixture 108 has a relatively low boiling point and may vaporize at typical reservoir 112 depths, though vaporization is not a necessity. The solvent mixture 108 is allowed sufficient time to percolate with the residual reserves 116. Some factors affecting the amount of time for the solvent mixture 108 to sufficiently penetrate and solvate the reservoir 112 include the porosity of the formation 112, the viscosity and gravity of the residual oil 116, and the temperature.

Upon contact with the solvent mixture 108, residual oil 116 is diluted and its mobility increases. Once the solvent mixture 108 has sufficiently penetrated the formation, gas drive from solvent mixture 108 is sufficient to drive recovery of oil 116 towards a production well 120 well where a pump 118 lifts the oil 116 to the surface.

While the figure shows an onshore drilling operation, those skilled in the art will appreciate that the methodology can be applied to offshore operations. Furthermore, the number of injection and production wells can vary, as can the spacing of the wells, as dictated by the characteristics of the hydrocarbon-bearing formation. Additionally, if desired, water, or a combination of water and surfactants can be used in conjunction with the solvent mixture in downhole use. Surfactants are molecules, often organic, possessing both hydrophobic and hydrophilic ends that are capable of lowering the interfacial tension between oil and water due to their ability to associate with oil via the hydrophobic chain, and with water via the hydrophilic head. Surfactants ease the passage of oil droplets from a reservoir in a more aqueous environment. However, the solvent mixture described herein is highly effective and economical by itself, rendering the use of additional compounds such as surfactants generally unnecessary. Emulsion-breaking compounds are not required when using the solvent mixture as the solvent mixture is highly effective at preventing emulsion formation. Nevertheless, the solvent mixture would be effective when used in conjunction with various other techniques currently being practiced, such as SAGD, CSS, steam and gas push, the solvent-based VAPEX, and others.

The solvent mixture can also be used to remediate undesirable organic compounds. It can be injected underground, generally at shallower depths than when recovering oil, and allowed to penetrate a contaminated reservoir. The hazardous organic matter is then recovered at a production well and contained. Gas emissions, common to most thermal-based remediation schemes, are avoided.

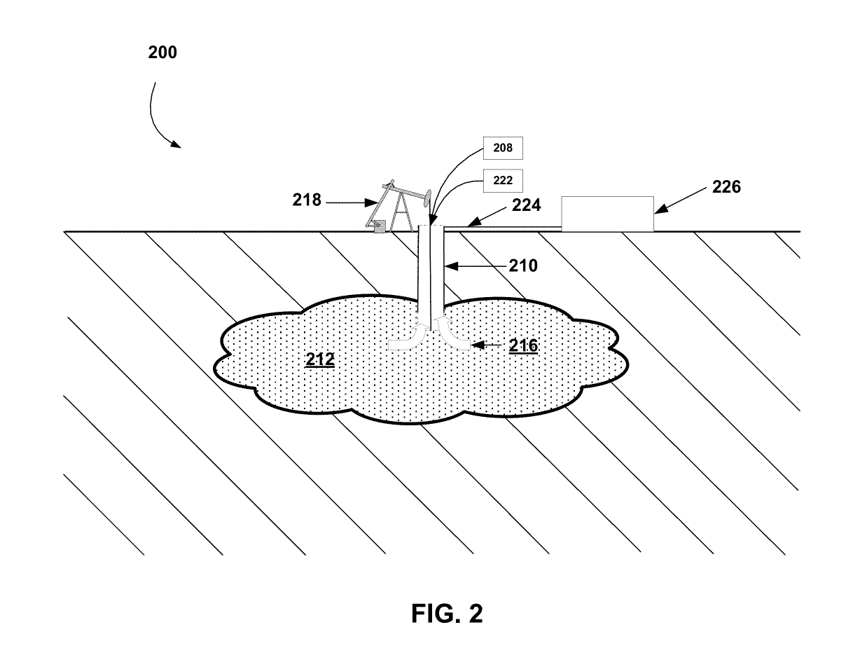

FIG. 2 shows a method 200 of extracting undesirable hydrocarbons 216 or heavy oil from a subterranean reservoir 212 in accordance with an embodiment of the invention. To facilitate the recovery of the undesirable hydrocarbons 216, the solvent mixture 208 is added to the reservoir 212 via a well 210 that extends through the earth into the subterranean reservoir 212 containing the undesirable hydrocarbon 216. In this figure, a single two-way well 210, which could be driven by a pumpjack 218 or other means, is used to both introduce the solvent mixture 208 described in the chemical composition of this disclosure and to recover the undesirable hydrocarbons 216 or oil.

Due to the shallower depths foreseeable in remediation efforts, the solvent mixture 208 might not reach its boiling point and vaporize. While vaporization is not required for the solvent mixture 208 to function, one can add moderately heated water 222 to increase the temperature and enable the solvent mixture 208 to vaporize, if desired. The solvent mixture 208 is allowed sufficient time to percolate with the residual reserves 216. Factors affecting the amount of time for the solvent mixture 208 to sufficiently penetrate and solvate the reservoir 212 include the geology and porosity of the particular formation 212, the viscosity and gravity of the residual oil 216 or undesirable organic compound being remediated, and reservoir temperature.

Upon contact with the solvent mixture 208, the undesirable hydrocarbon content 216 or heavy oil is diluted and it separates from water content in the reservoir, generally rising above the aqueous fraction. Its viscosity decreases and its API gravity increases, improving fluid mobility. Once the solvent mixture 208 has sufficiently penetrated the formation, the undesirable hydrocarbon 216 or oil is pumped to the surface. The undesirable hydrocarbons or oil are then pumped through a line 224 to a short-term storage tank 226.

The methodology illustrated in FIG. 2 can be used in offshore mining and in conjunction with chemical adjuncts or other methodologies to those skilled in the art.

FIG. 3 illustrates a simplified block diagram of a method 300 of obtaining oil, oil shale, or other hydrocarbons from oil sands, oil shale or other hydrocarbon-containing material in accordance with an embodiment of the invention.

Ore 302 containing oil sands, oil shale, or undesirable hydrocarbons to be remediated, is excavated and directed to a dedicated sizing unit 304 where the ore is pulverized, milled, ground, subjected to cyclonic vortex conditions, or other means, in order to greatly decrease particulate size. Smaller particulate size results in greater surface area, which leads to improved bonding opportunities with the solvent mixture. Reduced particulate size is of paramount importance with respect to treatment of oil shale.

Sized material is then sent by conveyor belt 306 to a mixing chamber 308 for the wash phase. The solvent mixture 350 can be showered onto the fine particulate matter as it travels by conveyor belt 306, or it can be added in the mixing chamber 308, where sized material and the solvent mixture 350 are thoroughly mixed. Typically the mixing chamber 308 is a large vat capable of holding 20 or more tonnes of raw material. A thorough mixing process allows the solvent mixture 350 to solvate molecules of oil or other hydrocarbon targets, and thus separate it from remaining excavated material. The amount of solvent mixture 350 and the mixing time, can both be adjusted so as to maximize saturation of sized material and enhance recovery. A mixture of oil or other recovered hydrocarbons and the solvent mixture 350 is drained from the chamber and sent to a sediment filter 318 which removes sediment particles as small as 3.0 μm 314.

Re-purified solvent mixture 350 is recycled in the next stages of the process. In a fractionator 330, the sediment-free mixture of oil or other recovered hydrocarbons and the solvent mixture 350, is heated moderately to 37.8° C. or higher in order to convert solvent mixture 350 from liquid to gas or vapor. Collected solvent vapors are drawn through a condenser 320 where they cool and re-liquefy before being recovered in a holding tank 322.

The recovered oil is diverted to a cooling system 324 that lowers temperatures sufficiently to enable them to be stored 326 prior to transportation to refineries. The oil sands in the wash chamber 308 are treated with the solvent mixture two or three times in order to maximize recovery. After the final wash, sediment is expelled 328 from the mixing chamber 308. The expelled sediment 328 can be returned to the environment without the need for further remediation.

Optionally, water heated to at least 37.8° C. can be added to the mixing chamber after the solvent mixture 350 has fully contacted and penetrated the particulate matter. The addition of water creates a distinct separation between an oil-containing phase, a water-containing phase, and cleaned sand. Density may differ depending on the physical properties of the hydrocarbons being recovered but the oil-containing phase will almost certainly have the lowest density and rise to the top. To fully clean the sand to the point at which it can be returned to the environment without needing additional remediation, additional applications of water may be required.

With oil sand or oil shale as the substrate, the process yields high API gravity, low viscosity crude oil. The entire process is very low in terms of carbon dioxide emissions and it creates no hazardous tail ponds.

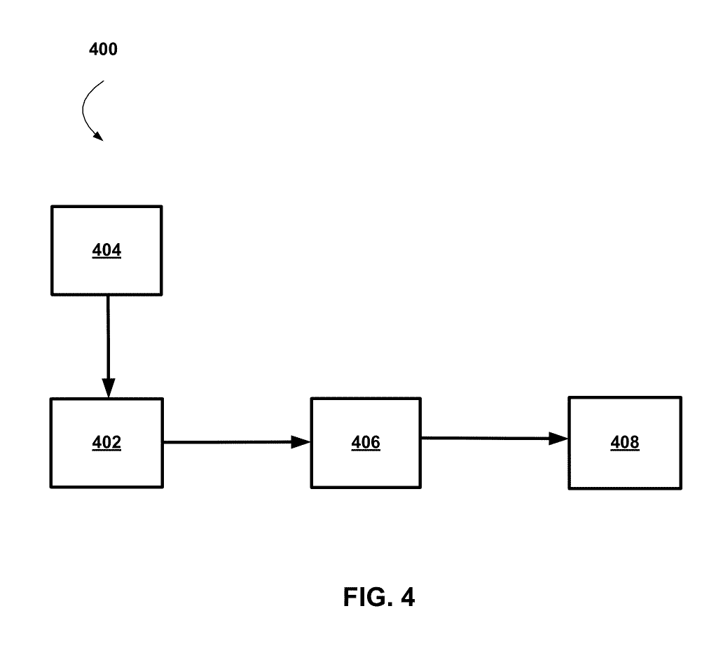

FIG. 4 is a simple block diagram of a method 400 of preparing heavy oil 402 for transportation via pipeline 406 to a refinery 408. The solvent mixture 404 described by the chemical composition disclosed herein is added to the heavy oil 402 in an amount sufficient to lower the viscosity of the heavy oil to a value that renders it pipelineable.

The pipeline transport 406 of oil 402 generally necessitates a minimum viscosity of under 800 cP. A minimum viscosity requirement of 500 cP is not uncommon. With a mixture composed of 80% heavy oil and 20% chemical composition 404, the viscosity of the heavy oil 402 is significantly decreased. In rare circumstances, such as transporting very heavy oil 402 in extremely cold conditions, it may be necessary to use higher amounts of the chemical composition 404.

The addition of the solvent mixture 404 to heavy oil 402 yields product with extremely minimal water content, reducing or eliminating the need to remove water at the refinery 408. The increased API gravity of heavy oil 402 treated with the chemical composition 404 ensures that it is capable of being processed at most refineries 408, unlike low gravity oil. It should also be noted that asphaltene precipitation has not been observed in heavy oil treated with the chemical composition, thus pipeline clogging can be avoided.

The present disclosure will be described in reference to the following examples and comparative examples. In all testing, the solvent mixture was prepared according to the guidelines provided in this disclosure.

### EXAMPLE 1

Observation of Fluid Samples

Four 50 ml test samples were prepared using different combinations of oil produced in Ventura County, Calif. The solvent mixture was prepared according to the described chemical composition. There is no special or preferred method of mixing the chemicals. The alkane component contained primarily heptane isomers, along with a much small quantity of octane isomers. The ratio of heptane isomers to octane isomers was greater than 25:1 in percentage by weight representation in the final mixture. The mixture included trace quantities of six and nine carbon alkanes. Diethyl ether was chosen as the ether molecule in the solvent mixture. Toluene was selected as the aromatic hydrocarbon.

One sample consisted solely of the produced oil. The second sample consisted of a blend of 25% chemical composition and 75% oil by volume. Another sample consisted of a blend of 50% chemical composition and 50% oil. The final sample consisted of a blend of 75% chemical composition and 25% oil. There is no special or preferred method of adding the chemical composition to oil.

50 ml of water was added to each sample, and the samples were agitated and placed into an oven at 37.8° C. Significantly, no emulsions formed as a result of the agitation. In less than five minutes, the mixture of the chemical composition along with the oil separated from the water and formed a distinct upper fraction. There was a narrow interface between the layers. Over the course of the twenty four hour evaluation, the chemical composition and oil did not separate from one another, though much of the composition evaporated.

### EXAMPLES 2 TO 25

Viscosity and Density of Super Heavy Oil Subjected to Different Amounts of Chemical Composition and Differing Temperatures

The ability of the solvent mixture to effect changes to the viscosity and density of heavy oil samples is critical to its usefulness. Testing was undertaken to measure some of these changes.

Eight 50 ml samples were prepared, as per the methods illustrated in Example 1. The solvent mixture was the same as that described in Example 1. The specific gravity (API°) was determined for each sample. The density (g/ml) and viscosity (centistokes and centipoises) were determined at three temperatures: 60° C., 71.1° C., and 93.3° C.

The results are shown in Table 1.

TABLE 1
Analysis of Viscosity and Density of Treated Super Heavy Oil

| | | Chemical Composition | Oil Gravity | | | | |
|---|---|---|---|---|---|---|---|
| | Crude | of Present Disclosure | at 15.56° C. | Temperature | Density | Viscosity | |
| | Oil (%) | (% vol) | (API°) | (° C.) | (g/ml) | Centisokes | Centipoise |
| Example 2 | 100 | 0 | 8.1 | 60.0 | 0.9855 | 29934 | 29500 |
| Example 3 | 100 | 0 | | 71.1 | 0.9786 | 15328 | 15000 |
| Example 4 | 100 | 0 | | 93.3 | 0.9649 | 2006 | 1935 |
| Example 5 | 75 | 25 | 15.2 | 60.0 | 0.9342 | 825 | 771 |
| Example 6 | 75 | 25 | | 71.1 | 0.9268 | 548 | 508 |
| Example 7 | 75 | 25 | | 93.3 | 0.9121 | 201 | 183 |
| Example 8 | 70 | 30 | 19.8 | 60.0 | 0.9058 | 371 | 336 |
| Example 9 | 70 | 30 | | 71.1 | 0.8986 | 246 | 221 |
| Example 10 | 70 | 30 | | 93.3 | 0.8843 | 90.5 | 80.1 |
| Example 11 | 60 | 40 | 21.8 | 60.0 | 0.8939 | 87.9 | 78.5 |
| Example 12 | 60 | 40 | | 71.1 | 0.8868 | 75.7 | 67.1 |
| Example 13 | 60 | 40 | | 93.3 | 0.8727 | 57.8 | 50.4 |
| Example 14 | 50 | 50 | 27.5 | 60.0 | 0.8618 | 56.2 | 48.5 |
| Example 15 | 50 | 50 | | 71.1 | 0.8550 | 54.1 | 46.2 |
| Example 16 | 50 | 50 | | 93.3 | 0.8414 | 50.1 | 42.1 |
| Example 17 | 40 | 60 | 29.6 | 60.0 | 0.8505 | 27.6 | 23.4 |
| Example 18 | 40 | 60 | | 71.1 | 0.8438 | 23.8 | 20.1 |
| Example 19 | 40 | 60 | | 93.3 | 0.8304 | 18.4 | 15.3 |
| Example 20 | 30 | 70 | 32.9 | 60.0 | 0.8341 | 14.2 | 11.8 |
| Example 21 | 30 | 70 | | 71.1 | 0.8274 | 10.7 | 8.9 |
| Example 22 | 30 | 70 | | 93.3 | 0.8143 | 6.7 | 5.5 |
| Example 23 | 25 | 75 | 37.6 | 60.0 | 0.8035 | 7.2 | 5.8 |
| Example 24 | 25 | 75 | | 71.1 | 0.7952 | 4.7 | 3.7 |
| Example 25 | 25 | 75 | | 93.3 | 0.7785 | 2.5 | 1.9 |

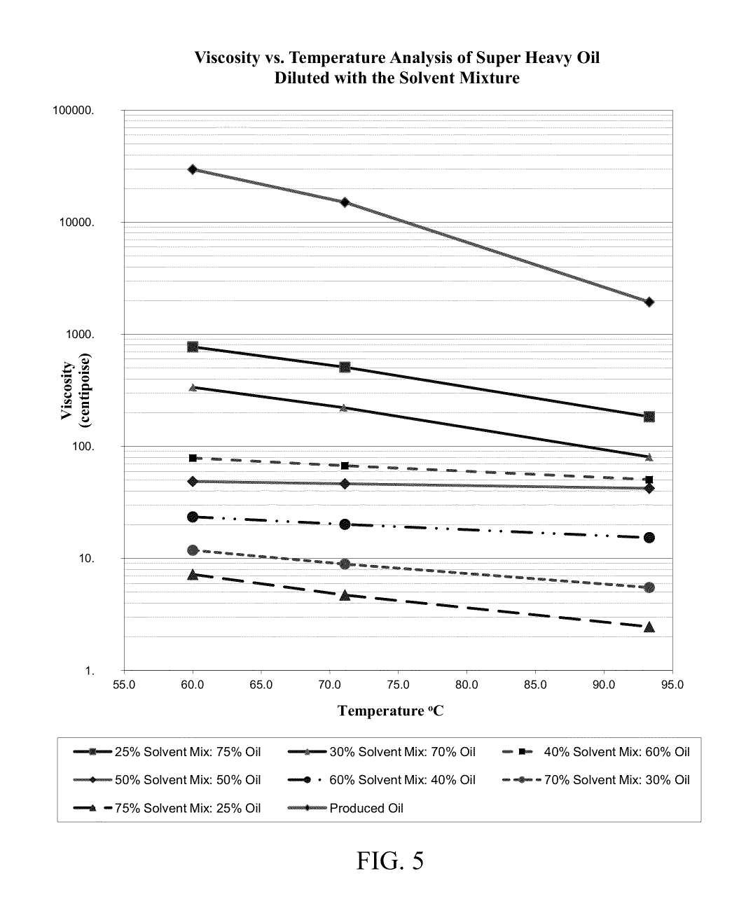

As shown in Table 1, the untreated oil sample had a very low API gravity of 8.1, classifying it as super heavy oil. Nonetheless, the treatment of this crude with the solvent mixture resulted in a significant increase in API gravity and a marked decrease in viscosity. Data is plotted graphically in FIG. 5. Viscosity, measured in centipoises, is displayed on the logarithmically scaled y-axis. With incrementally higher proportions of the chemical composition to oil, the API gravity increased and the viscosity decreased accordingly. A mixture by volume of 30% solvent mixture to 70% oil had an API gravity of 19.8, demonstrating significant fluidity given the extremely challenging oil sample.

### EXAMPLES 26 TO 41

Viscosity and Density of Heavy Oil Subjected to Different Amounts of Chemical Composition and Differing Temperatures

Additional testing was performed to reconfirm the ability of the solvent mixture to qualitatively and quantitatively improve heavy oil's viscosity and specific gravity. Testing was done using the solvent mixture as described in the disclosure. The solvent mixture comprised heptane isomers. Diethyl ether and toluene served as the ether and aromatic hydrocarbons components to the chemical composition.

Four additional 50 ml samples were prepared, as per the methods described for Example 1. The mixtures were composed as follows: (1) 100% crude oil, (2) 80% crude oil, 20% solvent mixture, (3) 70% crude oil, 30% solvent mixture, and (4) 60% crude oil, 40% solvent mixture. The specific gravity (API°) of each prepared sample was determined. The viscosity was measured at three temperatures: 60° C., 71.1° C., and 93.3° C. The density was determined at four temperatures: 15.6° C., 60° C., 71.1° C., and 93.3° C.

The results are shown in Table 2.

TABLE 2
Analysis of Viscosity and Density of Treated Heavy Oil

| | | Chemical Composition | Oil Gravity | | | | |
|---|---|---|---|---|---|---|---|
| | Crude | of Present Disclosure | at 15.56° C. | Temperature | Density | Viscosity | |
| | Oil (%) | (% vol) | (API°) | (° C.) | (g/ml) | Centisokes | Centipoise |
| Example 26 | 100 | 0 | 14.0 | 15.6 | 0.9726 | n/a | n/a |
| Example 27 | 100 | 0 | | 60.0 | 0.9421 | 768 | 723 |
| Example 28 | 100 | 0 | | 71.1 | 0.9346 | 374 | 349 |
| Example 29 | 100 | 0 | | 93.3 | 0.9197 | 113 | 104 |
| Example 30 | 80 | 20 | 23.2 | 15.6 | 0.9149 | n/a | n/a |
| Example 31 | 80 | 20 | | 60.0 | 0.8862 | 19.6 | 17.4 |
| Example 32 | 80 | 20 | | 71.1 | 0.8791 | 16.4 | 14.4 |
| Example 33 | 80 | 20 | | 93.3 | 0.8651 | 11.9 | 10.3 |
| Example 34 | 70 | 30 | 25.1 | 15.6 | 0.9037 | n/a | n/a |
| Example 35 | 70 | 30 | | 60.0 | 0.8753 | 14.1 | 12.4 |
| Example 36 | 70 | 30 | | 71.1 | 0.8683 | 11.5 | 9.99 |
| Example 37 | 70 | 30 | | 93.3 | 0.8545 | 8.05 | 6.88 |
| Example 38 | 60 | 40 | 32.9 | 15.6 | 0.8606 | n/a | n/a |
| Example 39 | 60 | 40 | | 60.0 | 0.8336 | 5.31 | 4.43 |
| Example 40 | 60 | 40 | | 71.1 | 0.8269 | 4.21 | 3.48 |
| Example 41 | 60 | 40 | | 93.3 | 0.8138 | 2.84 | 2.31 |

The oil sample used in the series of tests shown here in Table 2 was less viscous than that used to generate the Table 1 data. With an API gravity of 14.0, this oil represents a fairly typical heavy oil.

A mixture composed of only 20% solvent mixture versus 80% oil sample, by volume, was able to increase the API gravity to 23.2. The solvent mixture also showed great effectiveness in reducing the viscosity of the oil samples. These values suggest that the solvent mixture can be effective at lower volumes than existing diluents, such as natural gas condensates, diesel and naptha. 30% by volume mixtures of these diluents to heavy oil are common in the industry, often with less impressive decreases in heavy oil viscosity.

### EXAMPLES 42 TO 44

Oil Recovery from Core Sample Plugs

A three foot section of core from a well in Ventura County, Calif. provided a source of low API gravity oil-saturated material for purposes of testing the performance of the chemical composition. Several one and a half inch cylindrical sample plugs were taken from the core section.

A baseline, untreated plug and a diesel-treated core sample were also subjected to testing for control and comparative purposes. Diesel is known to those skilled in the art as a common diluent for viscous oil. Results are shown in Table 3.

The core sample plugs, taken from a depth of slightly more than 2185 feet, were mounted in hydrostatic core holders at pressures of 5,516 kilopascal (kPa). The temperature was raised to 71.1° C.

One sample core plug was kept at 71.1° C. for ten hours and then subjected to a 71.1° C. water flood. Flooding continued for 26 hours, at which point the effluent represented 99.9% water. Close to two pore volumes of water passed through the sample. It was observed that after an initially high rate of flow there was a significant decrease in flow rate. This sample plug serves as an untreated control.

A second core sample plug was heated to 71.1° C. at 5,516 kPa and then the solvent mixture as described above in Example 1, was injected into the plug. An amount of solvent mixture equivalent to approximately half the pore volume of the plug was injected. The sample soaked for approximately ten hours and then a 71.1° C. water flood commenced. After approximately six hours the effluent reached 99.9% water. Roughly 94 pore volumes of water had passed through the core sample plug.

The third core sample plug underwent the same treatment as the plug injected with the disclosed chemical composition, except diesel was injected instead. Diesel is well known to those skilled in the art as a useful diluent in the recovery of viscous oil, thus it served as a highly useful comparison in the testing. The effluent from the subsequent 71.1° C. water flood was 99.9% water after approximately 24 hours. As with the untreated control described above, the water flow rate slowed drastically after an initial burst, and only two pore volumes managed to pass through the sample plug.

TABLE 3
Hot Water Flood Summary

| | Initial Oil | Residual Oil | |
|---|---|---|---|
| | Saturation; | Saturation; | Oil Recovery; |
| | fraction | fraction | fraction oil |
| | pore space | pore space | in place |
| Example 42— | 0.929 | 0.786 | 0.154 |
| Untreated | | | |
| Control | | | |
| Example 43— | 0.930 | 0.496 | 0.656 |
| Chemical | | | |
| Composition | | | |
| Example 44— | 0.927 | 0.721 | 0.224 |
| Diesel | | | |

Oil recovery from the sample plug treated with the disclosed chemical composition reached 65.6%. This compared extremely favorably to recoveries of approximately 22.4% with diesel, and 15.4% to the control sample that had no treatment other than the hot water flood. The performance of the chemical composition is even more impressive when considering the fact that the core plug used in testing the chemical composition provided much lower permeability to air than the core plug used with diesel. This suggests highly effective penetration by the chemical composition.

### EXAMPLES 45 to 50

Composition of Oil After Being Subjected to Chemical Composition

Testing was performed with the solvent mixture and crude oil samples in order to determine the chemical properties of treated oil. Oil was incubated with the solvent mixture for a lengthy period of time to ensure saturation. The subsequent analysis included a determination of the quantity of nitrogen through chemiluminescence, the measurement of sulfur by energy dispersive X-ray fluorescence spectroscopy, and SARA analysis, which quantified saturates, aromatics, resins, asphaltenes, and light end loss in the oil sample. Results are shown in Table 4.

TABLE 4
Analysis of Chemical Properties of Heavy
Oil Treated for Pipeline Transport

| | Untreated Crude | Treated Crude | Units |
|---|---|---|---|
| SARA: | | | |
| Example 45 Saturates | 30.1 | 27.8 | wt % |
| Example 46 Aromatics | 59.1 | 56.6 | wt % |
| Example 47 Resins | 1.1 | 1.0 | wt % |
| Example 48 Asphaltenes | 8.6 | 9.3 | wt % |
| Nitrogen and Sulfur: | | | |
| Example 49 Nitrogen | 5509 | 5130 | mg/kg |
| Example 50 Sulfur | 0.900 | 0.842 | wt % |

The SARA analysis indicated that after treatment with the chemical composition, the oil remained similar to untreated oil with respect to the percentage composition of saturates and aromatics. This suggests that refining oil previously subjected to the chemical composition would be desirable feedstock, capable of yielding kerosene and diesel, amongst others products. By contrast, oil that has been subjected to cracking processes tends to be broken down to a higher degree, hindering the recovery of kerosene and diesel through refining.

Asphaltene content remained virtually unchanged in terms of percentage weight following treatment of oil with the chemical composition. This result reinforces other observations and supports the idea that the asphaltene fraction exists as a stable colloidal dispersion in treated samples, and does not precipitate.

The untreated crude oil sample was relatively high in nitrogen and sulfur content, neither of which is desirable at the refining stage. The values of both nitrogen and sulfur decreased by approximately six percent following treatment with the solvent mixture. While the change in nitrogen and sulfur composition was relatively minor, this would still provide a modest decrease in the refining workload.

### EXAMPLES 51 TO 52

Viscosity and Density of a Fraction Extracted from Shale by Treatment with the Chemical Composition

A large piece of California shale was coarsely fragmented with a hammer, yielding pieces from one to five centimeters in diameter. Approximately one and a half pounds of shale pieces was placed into two reaction vessels. The chemical composition was added to both vessels, creating a mixture of approximately 20% solvent mixture to 80% shale, based on weight.

The two mixtures of shale and solvent were agitated briefly and then maintained at either 15.6° C. or 23.9° C. After soaking for about 24 hours, room temperature water was added to the vessels and the upper liquid fraction was removed.

TABLE 5
Analysis of Viscosity and Density of Treated California Shale

| | % Chemical | | Gravity | | | |
|---|---|---|---|---|---|---|
| | Composition | Temperature | at 15.56° C. | Density | Viscosity | |
| | (% wt) | (° C.) | (API°) | (g/ml) | Centisokes | Centipoise |
| Example 51 | 20 | 15.6 | 59.0 | 0.7426 | n/a | n/a |
| Example 52 | 20 | 23.9 | | 0.7359 | 0.703 | 0.517 |

Based on visual observation, the shale fragments disintegrated to a large degree after soaking with the solvent mixture. The ashy-colored top liquid layer appeared to contain hydrocarbons extracted from the shale, and that would coincide with informal results from earlier experimentation.

### EXAMPLE 53

Gas Chromatography Analysis of Upper Liquid Fraction Extracted from Shale with Chemical Composition

TABLE 6
Chromatography Data from Liquid Extracted from Shale

| | C₁₇ + C₁₈/ | Pr/ | | % < n | % > n | % n-C/ | Total |
|---|---|---|---|---|---|---|---|
| | Pr + Phy | Phy | CPI | C₁₃ | C₁₈ | Total | Area |
| Example | 1.42 | 0.73 | 1.10 | 4.4 | 90.3 | 11.2 | 1.8 |
| 53 | | | | | | | |

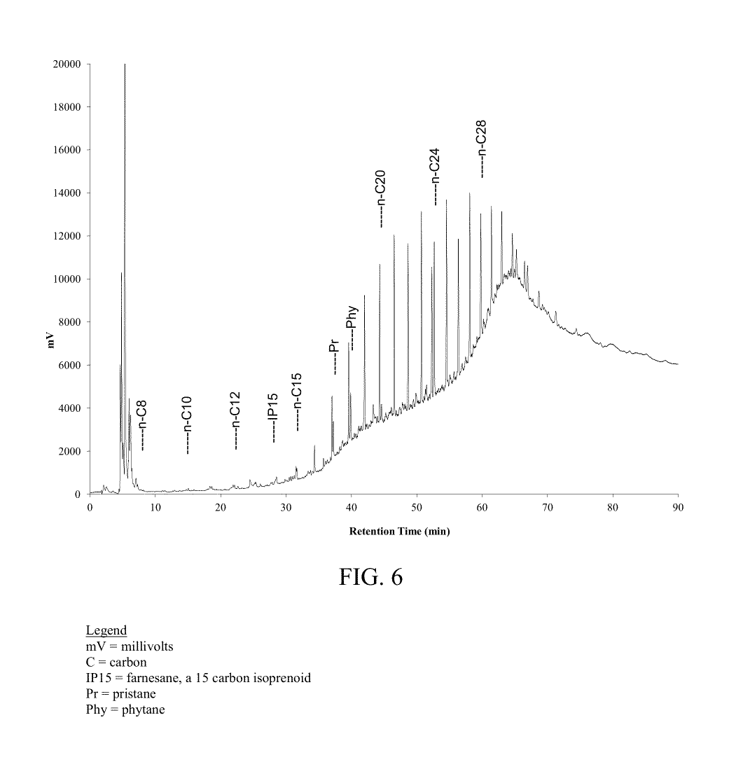

The chromatogram (see FIG. 6) displays the elution profile of the upper fraction that had been extracted from the sample of California shale after treatment with the solvent mixture, as described above in Table 5. Significantly, the results demonstrate an abundance of moderately-sized alkanes, characteristic of an oil-bearing sample. Clearly treatment of this particular shale with the solvent mixture led to very effective recovery of oil. While further testing should indicate the degree to which kerogens have been degraded, it is evident that treatment with the chemical composition was sufficient to release saturated alkanes and isoprenoids from kerogen in this California shale.

Standard measurements used in the industry to provide a “fingerprint” of a hydrocarbon source were taken. None of the values are intended to be probative; in some instances they provide possible insight into conditions surrounding the organic source. Isoprenoids such as pristane and phytane, bearing 19 and 20 carbon atoms per molecule respectively, are likely derived from chlorophyll sources such as phytol, for instance. Historically, a pristane to phytane ratio of less than 1.0 has been taken to indicate that a hydrocarbon source originated under anoxic conditions, though it is known that maturity and differences amongst precursors can also effect the value. As seen in Example 53 in Table 6, the hydrocarbon fraction extracted from the shale had a relatively low pristane to phytane ratio of 0.73.

The Carbon Preference Index (“CPI”) compares the quantity of odd-numbered alkanes to even-numbered alkanes. Hydrocarbons originating from plant or organism sources, younger sediment as well as some shale sources, have higher ratios of odd numbered carbons, and hence an elevated CPI. The 1.10 CPI value illustrated by Example 53 suggests relatively average maturity. The ratio of C₁₇ plus C₁₈ to pristine plus phytane is used because the similarly sized molecules generally maintain a relatively constant ratio, even following evaporative “weathering” and bacterial degradation, though it can increase over time if kerogen degrades.

Only 4.4 percent of hydrocarbon molecules in the analyzed fraction have less than 13 carbons, while just over 90 percent of hydrocarbons possess more than 18 carbons. Shale generally contains larger molecules, derived from algal and other living sources, hence shale oil displays a heavier distribution than that of lighter crudes.

The second last column in Table 6 shows “normal” carbon-containing molecules as a percentage of total volume. Here, normal carbons entail species containing between 10 and 30 carbons, excluding isoprenoids. The value of 11.2% indicates that treating this shale sample with the solvent mixture provided a significant quantity of high quality, desirable hydrocarbons. The area under the curve, measured as 1.8, represents total recovery of the hydrocarbon range analyzed, including molecules with up to 34 carbon atoms.

### EXAMPLES 54 TO 65

Viscosity and Density of Oil Subjected to Quantities of Chemical Composition Suitable for Rendering Heavy Oil for Pipeline Transport

Testing was performed using the solvent mixture at quantities relevant to the preparation of heavy oil for pipeline transport. The oil used came from a well in Kern County, California. The viscosity and specific gravity of heavy oil was tabulated. Testing was done using the solvent mixture as described in the disclosure. The solvent mixture comprised heptane isomers. Diethyl ether and toluene represented the ether and aromatic hydrocarbons comprising the other components to the chemical composition. There is no special or preferred method of adding the composition to the heavy oil.

Four 50 ml samples were prepared, as per the methods described for Example 1. The mixtures were composed as follows: (1) 100% crude oil, (2) 80% crude oil, 20% solvent mixture, (3) 75% crude oil, 25% solvent mixture, and (4) 70% crude oil, 30% solvent mixture. The viscosity was measured at two temperatures: 26.7° C., and 71.1° C. The density was determined at three temperatures: 15.6° C., 26.7° C., and 71.1° C.

The results are shown in Table 7.

TABLE 7
Analysis of Viscosity and Density of Heavy Oil Treated for Pipeline Transport

| | | Chemical Composition | Oil Gravity | | | | |
|---|---|---|---|---|---|---|---|
| | Crude | of Present Disclosure | at 15.56° C. | Temperature | Density | Viscosity | |
| | Oil (%) | (% vol) | (API°) | (° C.) | (g/ml) | Centisokes | Centipoise |
| Example 54 | 100 | 0 | 13.9 | 15.6 | 0.9733 | n/a | n/a |
| Example 55 | 100 | 0 | | 26.7 | 0.9656 | 3325 | 3211 |
| Example 56 | 100 | 0 | | 71.1 | 0.9352 | 102.9 | 96.3 |
| Example 57 | 80 | 20 | 20.9 | 15.6 | 0.9282 | n/a | n/a |
| Example 58 | 80 | 20 | | 26.7 | 0.9290 | 110 | 101 |
| Example 59 | 80 | 20 | | 71.1 | 0.8820 | 18.0 | 15.9 |
| Example 60 | 75 | 25 | 21.5 | 15.6 | 0.9249 | n/a | n/a |
| Example 61 | 75 | 25 | | 26.7 | 0.9176 | 90.9 | 83.4 |
| Example 62 | 75 | 25 | | 71.1 | 0.9001 | 14.9 | 13.2 |
| Example 63 | 70 | 30 | 24.4 | 15.6 | 0.9073 | n/a | n/a |
| Example 64 | 70 | 30 | | 26.7 | 0.9001 | 36.4 | 32.8 |
| Example 65 | 70 | 30 | | 71.1 | 0.8718 | 8.08 | 7.04 |

The data in Table 7 shows that adding 20% of the solvent mixture to a heavy oil sample was sufficient to increase the API gravity to 20.9. At 26.7° C., the viscosity of that treated sample was 101 cP, indicating the heavy oil was amenable to pipeline transport. This compares favorably to other diluents currently in use, wherein it is not uncommon to require a 30% diluent volume in order to render pipelineable heavy oil.

Those of skill in the art will appreciate that many modifications and variations are possible in terms of the disclosed embodiments of the invention, configurations, materials and methods without departing from their spirit and scope. Accordingly, the scope of the claims appended hereafter and their functional equivalents should not be limited by particular embodiments described and illustrated herein, as these are merely exemplary in nature.

1. A chemical composition for enhanced recovery of oil, comprising:
(a) an alkane having from five to nine carbon atoms;
(b) an ether; and
(c) an aromatic hydrocarbon.

2. The chemical composition of claim 1, wherein the amount of the alkane is from about 60% to about 80% by weight, the amount of the ether is from about 24% to about 32% by weight, and the amount of the aromatic hydrocarbon is from about 2.5% to about 3.5% by weight.

3. The chemical composition of claim 1, wherein the alkane is a straight-chain molecule.

4. The chemical composition of claim 1, wherein the alkane is a branched-chain molecule.

5. The chemical composition of claim 1, wherein the ether is diethyl ether.

6. The chemical composition of claim 1, wherein the ether is methyl n-propyl ether.

7. The chemical composition of claim 1, wherein the ether is methyl tert-butyl ether.

8. The chemical composition of claim 1, wherein the aromatic hydrocarbon is toluene.

9. The chemical composition of claim 1, wherein the aromatic hydrocarbon is benzene.

10. The chemical composition of claim 1, wherein the aromatic hydrocarbon is xylene.

11. The chemical composition of claim 1, wherein the aromatic hydrocarbon is ethylbenzene.

12. The chemical composition of claim 1, wherein the aromatic hydrocarbon is cumene.

13. The chemical composition of claim 1, wherein the aromatic hydrocarbon is durene.

14. A method for recovering crude oil from a subterranean reservoir containing oil, the method comprising:
(a) injecting a quantity of a chemical composition comprising an alkane having from five to nine carbon atoms, an ether, and an aromatic hydrocarbon into the reservoir via one or more wells;
(b) allowing the injected chemical composition to contact and penetrate the reservoir for a time sufficient to interact with oil; and
(c) recovering oil with lowered viscosity at one or more wells.

15. The method of claim 14, wherein step (b) includes the step of injecting water into the subterranean reservoir after the chemical composition has penetrated the reservoir for sufficient time.

16. The method of claim 14, wherein step (b) includes the step of injecting heated water or steam into the subterranean reservoir after the chemical composition has penetrated the reservoir for a sufficient time.

17. The method of claim 14, further comprising injecting the chemical composition prior to adding steam in the steam-assisted gravity drainage method.

18. The method of claim 14, further comprising injecting the chemical composition prior to adding steam and gas in the steam and gas push process.

19. The method of claim 14, further comprising injecting the chemical composition prior to adding steam in the cyclic steam stimulation process.

20. The method of claim 14, further comprising injecting the chemical composition with VAPEX.

21. The method of claim 15, wherein undesirable hydrocarbons are recovered from a subterranean reservoir.

22. A method for recovering oil from an oil sand deposit, the method comprising:
(a) introducing excavated, bituminous material that has been pulverized to particulate matter;
(b) introducing a chemical composition of claim 1 comprising an alkane having from five to nine carbon atoms, an ether, and an aromatic hydrocarbon, to the particulate matter;
(c) mixing the chemical composition and the particulate matter in a mixing chamber;
(d) allowing sufficient time for the chemical composition to contact and penetrate the particulate matter, causing oil to rise to the top of the mixing chamber and sand and other particulate matter to settle on the bottom of the mixing chamber;
(e) extracting the oil-containing top fraction from the mixing chamber to a sediment filter to remove particles as small as 30×10⁻⁶ m;
(f) directing the liquid remaining following sediment removal to a vessel constituting a closed loop system, where temperatures rise to about 37.8° C. or higher, vaporizing the solvent mixture of the chemical composition;
(g) directing the vapors up through a cooling system, allowing the chemical composition to re-liquefy and be recycled to a holding tank for re-use; and
(h) directing the purified oil fraction to a cooling system where its temperature is lowered.

23. The method of claim 22, wherein the fraction that settled on the bottom of the mixing chamber in 22(d) undergoes the wash process of 22(b) to 22(h) a second time.

24. The method of claim 22, wherein the excavated and pulverized material is oil shale.

25. The method of claim 22, wherein the excavated and pulverized material is known to possess undesirable hydrocarbons.

26. The method of claim 22, wherein water heated to a temperature of at least 37.8° C. is added to the mixing chamber after the solvent mixture has sufficiently contacted and penetrated the particulate matter.

27. A method for improving the transport of oil through a pipeline, the method comprising introducing to the oil an amount of the a chemical composition comprising an alkane having from five to nine carbon atoms, an ether, and an aromatic hydrocarbon, sufficient to lower the viscosity at 26.7° C. to less than 500 cP.
